(19) United States
(12) Patent Application Publication
(10) Pub. No.: US 2006/0129984 A1
(43) Pub. Date: Jun. 15, 2006

(54) Multi-language software executing method and system thereof

(75) Inventor: Patrick Chen, Shindian City (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/216,087

(22) Filed: Sep. 1, 2005

(30) Foreign Application Priority Data
Dec. 14, 2004 (TW) 093138793

(51) Int. Cl. G06F 9/44

(52) U.S. Cl. 717/120; 717/114

(57) ABSTRACT

A multi-language software executing system comprises a language-code selecting module and a language-code-string selecting module. The language-code selecting module correspondingly selects out a language-family name from a language-family table in a first file according to an environment language-code, and selects a first language-code or a second language-code from a language-code table in the first file as a candidate language-code according to the language-family name and the environment language-code. The language-code-string selecting module correspondingly selects out a candidate string from a second file according to the candidate language-code. The language-code-string selecting module selects a first language-code string from the second file as the candidate string when the candidate language-code is the first language-code, and selects a second language-code string from the second file as the candidate string when the candidate language-code is the second language-code.

### BACKGROUND OF THE INVENTION

1. Field of Invention

The invention relates to a language system and, in particular, to a multi-language software executing method and system thereof.

2. Related Art

In order to globalize the information of computer systems, the operating interface of some software or documents showing words of at least one language are easy to be understood or operated for users.

With reference to FIG. 1, if a software installation is requested to provide the interface of Chinese, English or Japanese etc, the software installation selects the requested language strings from a multi-language file 1 during the installation. Accordingly, the interface can be presented in selected language strings during the installation. The multi-language file 1 includes a language-family table 11, a language-code table 12 and language strings 13. The software installation selects the language strings 13 corresponding to the language-family table 11 and the language-code table 12 according to the language-code and the language-name of the installed environment.

As the multi-language file contains more and more various language words, the software installation or other software using multi-language file are able to support more widespread languages. However, the greater part in the multi-language file is unnecessary for the system operated by different users of different languages. Otherwise, it is not easy to maintain the various multi-language strings recorded in the same and single multi-language file. Furthermore, some platforms are not able to present the multi-language strings because the multi-language file is larger than 64 KB.

It is therefore a subject of the invention to provide a multi-language software executing system and its method, which can dispersedly record the multi-language strings. Thus the multi-language file is reduced in file size and is easy to be maintained.

### SUMMARY OF THE INVENTION

In view of the foregoing, the invention is to provide a multi-language software executing method and system, which are able to dispersedly record the multi-language strings.

The multi-language software executing system comprises a language-code selecting module and a language-code-string selecting module. The language-code selecting module selects out a language-family name from a language-family table in a first file according to an environment language-code, and selects a first language-code or a second language-code from a language-code table in the first file as a candidate language-code according to the language-family name and the environment language-code. The language-code-string selecting module selects out a candidate string from a second file according to the candidate language-code. The language-code-string selecting module selects a first language-code string from the second file as the candidate string when the candidate language-code is the first language-code, and selects a second language-code string from the second file as the candidate string when the candidate language-code is the second language-code.

In addition, the invention provides a multi-language software executing method. The multi-language software executing method comprises the steps of correspondingly selecting out a language-family name from a language-family table in a first file according to an environment language-code, selecting out a first language-code or a second language-code as a candidate language-code from a language-code table in the first file according to the language-family name and the environment language-code, and correspondingly selecting out a candidate string from a second file according to the candidate language-code, wherein the candidate string is a first language-code string selected from the second file when the first language-code is selected as the candidate language-code or the candidate string is a second language-code string selected from the second file when the second language-code is selected as the candidate language-code. [0009] Furthermore, the invention provides a storage medium recording a computer readable multi-language program. The storage medium is provided for a host system (such as a computer) to implement the multi-language software executing method described above by executing the multi-language program. [0010] As mentioned above, since the multi-language software executing system and method of the invention dispersedly record the language-family table and the language-code table, the first language-code string and the second language-code string in the first file and the second file. Then the language-code selecting module selects out the requested candidate language-code from the first file or the second file. Thus the multi-language strings are dispersedly recorded. The multi-language files are reduced in file size and easy to maintain.

### BRIEF DESCRIPTION OF THE DRAWINGS

The invention will become more fully understood from the detailed description given herein below illustration only, and thus is not limitative of the present invention, and wherein:

FIG. 1 is a diagram showing the conventional multi-language file;

FIG. 2 is a block diagram showing a multi-language software executing system according to a preferred embodiment of the application;

FIGS. 3A to 3C are a set of diagrams showing the multi-language software executing system according to the preferred embodiment of the application;

FIG. 4 is a flowing chart showing a multi-language software executing method according to the preferred embodiment of the application; and

FIG. 5 is a block diagram showing a storage medium according to the preferred embodiment of the application.

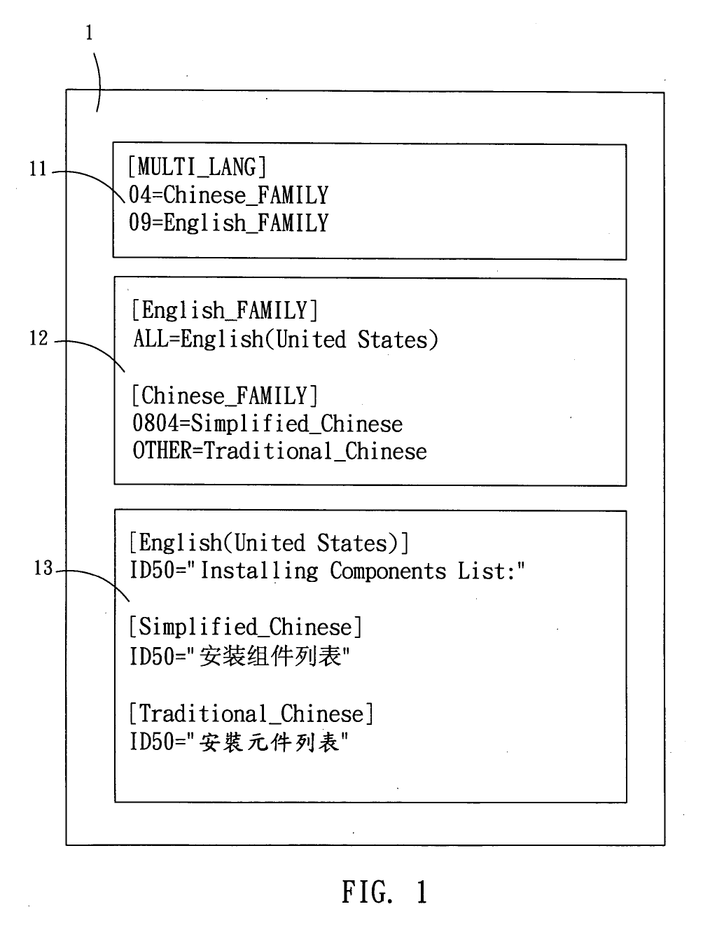

### DETAILED DESCRIPTION OF THE INVENTION

The present invention will be apparent from the following detailed description, which proceeds with reference to the accompanying drawings, wherein the same references relate to the same elements.

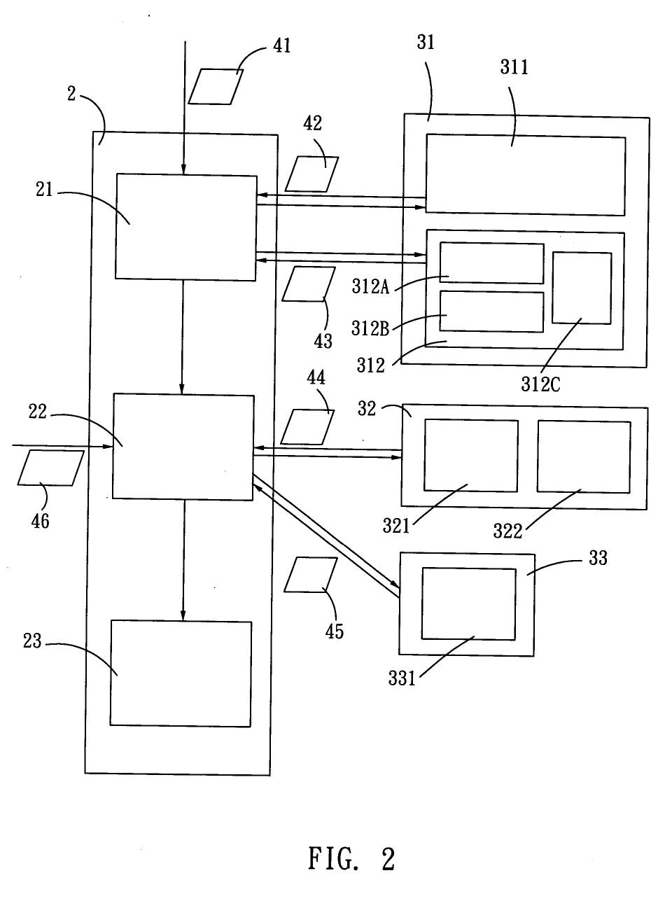

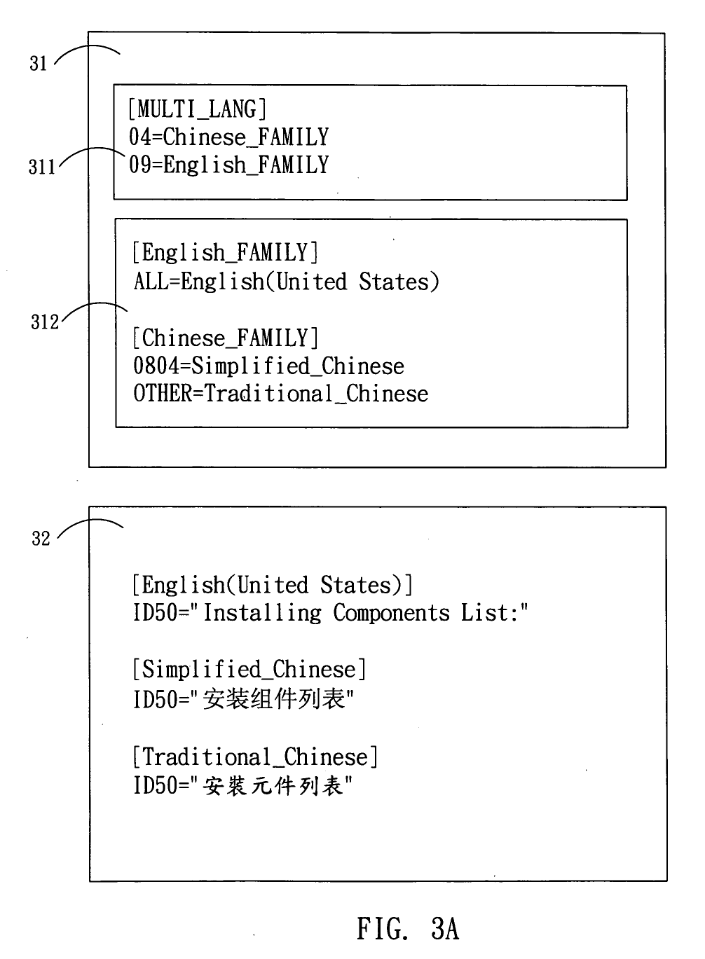

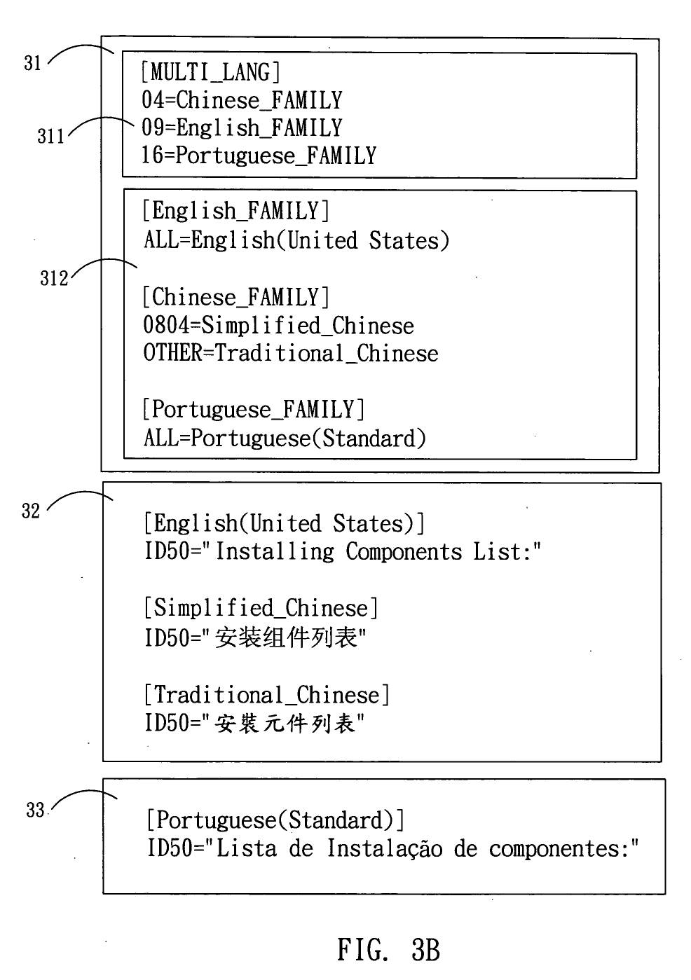

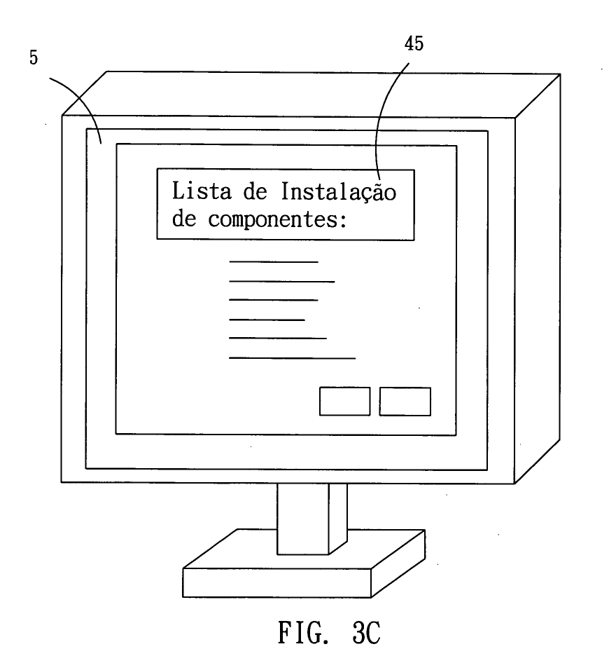

With reference to FIG. 2 and FIG. 3A, the multi-language software executing system 2 comprises a language-code selecting module 21 and a language-code-string selecting module 22. The language-code selecting module 21 correspondingly selects out a language-family name 42 from a language-family table 311 in a first file 31 according to an environment language-code 41. And the language-code selecting module 21 selects a first language-code 312A and a second language-code 312B from a language-code table 312 in the first file 31 as a candidate language-code 43 according to the language-family name 42 and the environment language-code 41. The language-code-string selecting module 22 correspondingly selects out a candidate string 44 from a second file 32 according to the candidate language-code 43. The language-code-string selecting module 22 selects a first language-code string 321 from the second file 32 as the candidate string 44 if the candidate language-code 43 is the first language-code 312A. Otherwise, the language-code-string selecting module 22 selects a second language-code string 322 from the second file 32 as the candidate string 44 if the candidate language-code 43 is the second language-code 312B. The first 31 and the second 32 are text files. Furthermore, the language-code-string selecting module 22 selects out the corresponding candidate string 44 from the second file 32 according to an executing-identification 46 in the multi-language software executing system 2. The executing-identification 46 can be an error-code, a corresponding string code, or an environment set-code etc.

In the embodiment, the executing-identification 46 is “ID50” and the environment language-code 41 is “0804” where the “04” represents the language-family. Then the language-code selecting module 21 selects out the corresponding language-family name 42, which is “Chinese_FAMILY” corresponding to the code “04”, from the language-family table 311. And the language-code selecting module 21 selects “Simplified_Chinese” from the language-code table 312 in the first file 31 as the candidate language-code 43 according to the language-family name 42 “Chinese_FAMILY” and the environment language-code 41 “0804”. Therefore, the language-code-string selecting module 22 selects” from the segment of “Simplified_Chinese” in the second file 32 as candidate string 44 according to the candidate language-code 43 “Simplified_Chinese” and the executing-identification 46 “ID50”. In addition, when the “Other” is set for the “Traditional_Chinese” in the language-code table 312, “Traditional_Chinese” is selected as the candidate language-code 43 on condition that the language-family name 42 is “Chinese_FAMILY” and the environment language-code 41 is not “0804”.

With reference to FIG. 2 and FIG. 3A, in the embodiment, the language-code selecting module 21 selects one of the first language-code 312A, second language-code 312B or the third language-code 312C from the language-code table 312 as the candidate language-code 43 according to the language-family name 42 and the environment language-code 41. The language-code-string selecting module 22 selects out the candidate string 45 from the second file 32 and a third file 33 according to the candidate language-code 43. As the candidate language-code 43 is the third language-code 312C, the language-code-string selecting module 22 selects a third language-code string 331 as candidate string 45 from the third file 33. The third file 33 is a text file. Furthermore, the language-code-string selecting module 22 selects out the corresponding candidate string 44 from the third file 33 according to the executing-identification 46.

In the embodiment, the executing-identification 46 is “ID50” and the left 2 characters of the environment language-code 41 are “16”. The language-code selecting module 21 selects out the corresponding language-family name 42, which is “Portuguese_FAMILY” corresponding to the code “16”, from the language-family table 311. And the language-code selecting module 21 selects out the candidate language-code 43 “Protuguese(Standard)” from the language-code table 312 in the first file 31 according to the language-family name 42 “Protuguese_FAMILY” and the environment language-code 41. In addition, when “All” is set for the “Protuguese(Standard)” in the language-code table 312, “Protuguese(Standard)” is selected as the candidate language-code 43 on condition that the language-family name 42 is “Protuguese_FAMILY” and left 2 characters of the environment language-code 41 are “16” regardless of the other characters of the environment language-code 41. Therefore, the language-code-string selecting module 22 selects “Lista de Instalagao de componentes:” as candidate string 45 from the segment of “Protuguese(Standard)” in the third file 33 according to the candidate language-code 43 “Protuguese(Standard)” and the executing-identification 46 “ID50”.

With reference to FIG. 2 and FIG. 3C, in the embodiment, the multi-language software executing system 2 further comprises a language-code-string output module 23. The output module 23 outputs and presents the candidate string 44 or 45 in a monitor 5. In addition, the multi-language software executing system can be a software installation system.

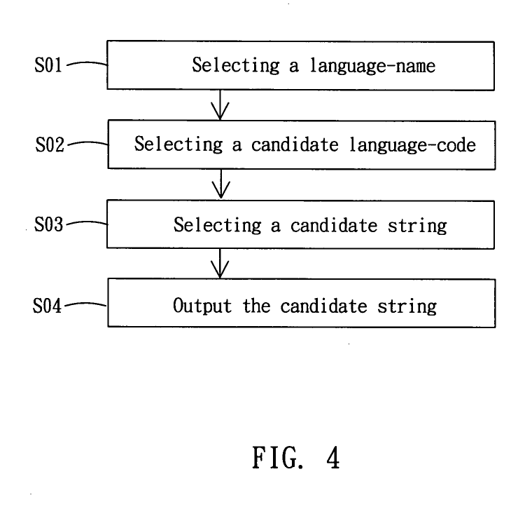

With reference to FIG. 4, FIG. 4 depicts a flowing chart showing a multi-language software executing method according to the preferred embodiment of the application. The method comprises 4 steps.

Step S01 correspondingly selects out a language-family name from a language-family table in a first file according to an environment language-code.

Step S02 selects out a candidate language-code from a first language-code and a second language-code recorded in a language-code table in the first file according to the language-family name and the environment language-code. In addition, in the embodiment, Step S02 can select the first language-code, the second language-code or a third language-code as the candidate language-code from the language-code table in the first file.

Step S03 correspondingly selects out a candidate string from a second file according to the candidate language-code. When the first language-code is selected as the candidate language-code in step S02, step S03 selects a first language-code string as the candidate string from the second file. Otherwise, when the second language-code is selected as the candidate language-code in step S02, step S03 selects a second language-code string as the candidate string from the second file. I the embodiment, step 903 can select out the candidate string from the second file or a third file. When a third language-code is selected, step S03 selects a third language-code string as the candidate string from the third file.

Step S04 outputs the candidate string to a monitor for presentation.

Furthermore, the invention provides a storage medium (ex: optical disk, floppy disk or removable hard disk, etc) recording a computer readable multi-language program. The storage medium is easy to carry and is conveniently provided for a host system (such as a computer) to implement the multi-language software executing method described above by executing the multi-language program. Besides, the multi-language software executing system recorded on the storage medium is basically consisted of several program segments, which are corresponding to the embodiments described above.

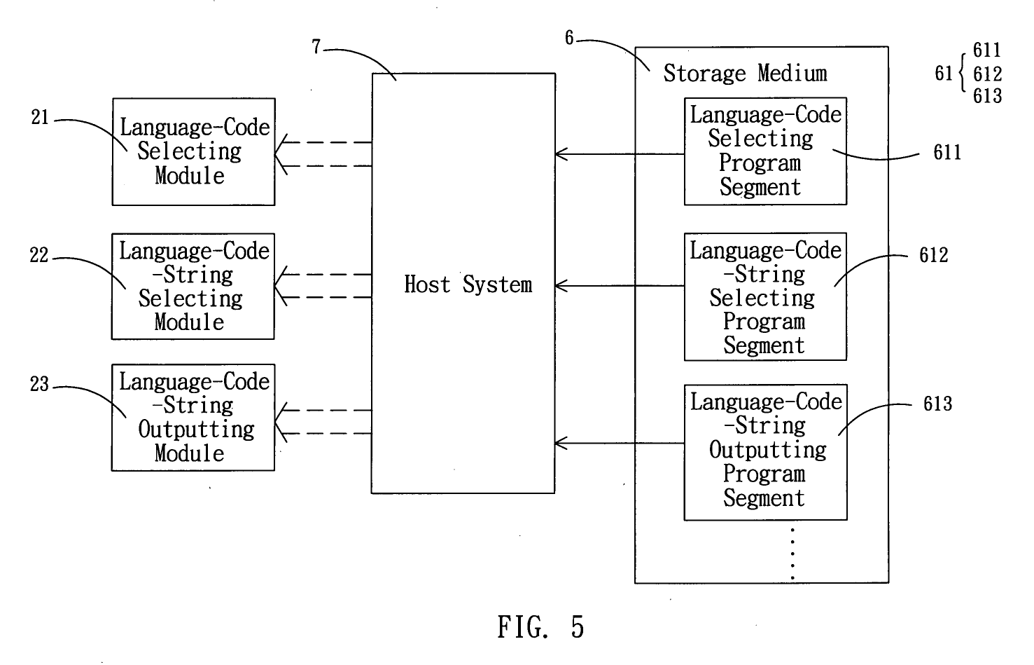

With reference to FIG. 5, storage medium 6 records a multi-language program 61. The multi-language program 61 comprises a language-code selecting program segment 611, a language-code-string selecting program segment 612, and a language-code-string outputting program segment 613, which are executable for a host system 7 (ex: a computer). After executing, the language-code selecting program segment 611, the language-code-string selecting program segment 612, and the language-code-string outputting program segment 613 are individually corresponding to the language-code selecting module 21, the language-code-string selecting module 22, and the language-code-string outputting module 23 the in function described above. Therefore, the detailed descriptions of the program segments 611-613 are not repeated hereinafter.

As mentioned above, since the multi-language software executing system and method of the invention dispersedly record the language-family table and the language-code table, the first language-code string and the second language-code string in the first file and the second file. Then the language-code selecting module selects out the requested candidate language-code from the first file or the second file. Thus the multi-language strings are dispersedly recorded. The multi-language files are reduced in file size and easy to maintain.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A multi-language software executing system, comprising:
a language-code selecting module, which selects out a language-family name from a language-family table in a first file according to an environment language-code, and selects a first language-code or a second language-code from a language-code table in the first file as a candidate language-code according to the language-family name and the environment language-code; and
a language-code-string selecting module, which selects out a candidate string from a second file according to the candidate language-code, wherein the language-code-string selecting module selects a first language-code string from the second file as the candidate string when the candidate language-code is the first language-code, and selects a second language-code string from the second file as the candidate string when the candidate language-code is the second language-code.

2. The multi-language software executing system as recited in claim 1, wherein the language-code-string selecting module selects out the candidate string from the second file according to the candidate language-code and an executing state of the multi-language software executing system.

3. The multi-language software executing system as recited in claim 1, wherein the language-code table further comprises a third language-code, and the language-code-string selecting module selects a third language-code string as the candidate string from a third file when the third language-code is selected as the candidate language-code.

4. The multi-language software executing system as recited in claim 3, wherein the language-code-string selecting module selects out the candidate string from the second file or the third file according to the candidate language-code and an executing state of the multi-language software executing system

5. The multi-language software executing system as recited in claim 4, wherein at least one of the first file, the second file and the third file is a text file.

6. The multi-language software executing system as recited in claim 1, further comprising:
a language-code-string outputting module, which outputs the candidate string.

7. A multi-language software executing method, comprising:
selecting out a language-family name from a language-family table in a first file according to an environment language-code;
selecting a first language-code or a second language-code as a candidate language-code from a language-code table in the first file according to the language-family name and the environment language-code; and
selecting out a candidate string from a second file according to the candidate language-code, wherein the candidate string is a first language-code string selected from the second file when the first language-code is selected as the candidate language-code, or the candidate string is a second language-code string selected from the second file when the second language-code is selected as the candidate language-code.

8. The multi-language software executing method as recited in claim 7, wherein the step of correspondingly selecting out the candidate string from the second file according to the candidate language-code comprises:
selecting out the candidate string from the second file according to the candidate language-code and an executing state.

9. The multi-language software executing method as recited in claim 8, further comprising:
selecting a third language-code as the candidate language-code from the language-code table according to the language-family name and the environment language-code; and
selecting a third language-code string as the candidate string from a third file.

10. The multi-language software executing method as recited in claim 11, further comprising:
selecting out the candidate string from the third file according to the candidate language-code and an executing state.

11. The multi-language software executing method as recited in claim 10, wherein at least one of the first file, the second file and the third file is a text file.

12. The multi-language software executing method as recited in claim 8, further comprising:
outputting the candidate string.

13. The multi-language software executing method as recited in claim 8, wherein the multi-language software executing method is executed in a multi-language software installation system.

14. A storage medium recording a computer readable multi-language program, the multi-language program comprises:
a language-code selecting program segment, which impels a host system to select out a language-family name from a language-family table in a first file according to an environment language-code, and to select a first language-code or a second language-code as a candidate language-code from a language-code table in the first file according to the language-family name and the environment language-code; and
a language-code-string selecting program segment, which impels the host system to select out a candidate string from a second file according to the candidate language-code, wherein the host system selects a first language-code string as the candidate string from the second file when the first language-code is selected as the candidate language-code, or the host system selects a second language-code string as the candidate string from the second file when the second language-code is selected as the candidate language-code.

15. The storage medium as recited in claim 14, wherein the host system selects out the candidate string from the second file according to the candidate language-code and an executing state of the host system.

16. The storage medium as recited in claim 15, wherein the language-code table further comprises a third language-code, and the host system selects a third language-code string as the candidate string from a third file when the third language-code is selected as the candidate language-code.

17. The storage medium as recited in claim 16, wherein the host system selects out the candidate string from the second file or the third file according to the candidate language-code and an executing state of the multi-language software executing system.

18. The storage medium as recited in claim 17, wherein at least one of the first file, the second file and the third file is a text file.

19. The storage medium as recited in claim 16, wherein the multi-language program further comprising:
a language-code-string outputting program segment, which is for the host system to output the candidate string.
